(19) United States
(12) Patent Application Publication
(10) Pub. No.: US 2024/0399708 A1
(43) Pub. Date: Dec. 5, 2024

(54) ADHESIVES, PROCESSES FOR MAKING AND USING SAME, AND PRODUCTS MADE THEREWITH

(71) Applicant: ECOLAB USA INC., ST. PAUL, MN (US)

(72) Inventors: Winai Naewnoingam, Banpong (TH); Attapol Malaikaew, Muang (TH); William C Johnson, Chicago, IL (US); Ana Carolina Mazarin de Moraes, Westmont, IL (US)

(73) Assignee: ECOLAB USA INC., ST. PAUL, MN (US)

(21) Appl. No.: 18/732,883

(22) Filed: Jun. 4, 2024

Related U.S. Application Data
(60) Provisional application No. 63/506,259, filed on Jun. 5, 2023.

(51) Int. Cl. B32B 7/12; B32B 29/08; D21H 19/16; D21H 19/24

(52) U.S. Cl. CPC B32B 7/12; B32B 29/08; D21H 19/16; D21H 19/24; B32B 2305/74

(57) ABSTRACT

Compositions, processes for making and using same, and products made therewith. In some embodiments, the composition can include a polysaccharide and an alkyl alcohol alkoxylate having a formula of RO[(CH₂CHCH₃O)ₓ(CH₂CH₂O)_{y}]M, where R is a C₄-C₄₀ alkyl, x is 1 to 50, y is 0 to 100, and M is H or an alkali metal. In some embodiments, the composition can also include water such that the composition can be in the form of an aqueous mixture. In some embodiments, the composition can also include a base compound. In some embodiments, the composition can also include a boron-containing compound.

### CROSS REFERENCE TO RELATED APPLICATION

This application claims priority to U.S. Provisional Patent Application No. 63/506,259, filed on Jun. 5, 2023, which is incorporated by reference herein.

### FIELD

Embodiments described generally relate to compositions, process for making and using same, and products made therewith. More particularly, such embodiments relate to compositions that include a polysaccharide and an alkyl alcohol alkoxylate, process for making and using same, and products made therewith.

### BACKGROUND

Cardboard is typically made by passing a cellulosic sheet between corrugating rolls to form a corrugated sheet that includes a generally sinusoidal or serpentine cross-section, i.e., corrugations. An adhesive is applied to tips of the corrugations and a noncorrugated or planar cellulosic liner is applied against the adhesive coated tips of the corrugations as the corrugated sheet passes between a corrugating roll and a pressure roll. The resulting paper product that includes the corrugated sheet on one side and the liner on the other side is called a single-faced web. The single-faced web can be used as is in some applications, e.g., as buffer material within a container. More often, however, adhesive is applied to the tips of the corrugations of the single-faced web and a second noncorrugated or planar cellulosic liner is applied against the adhesive coated tips of the corrugations to form a sheet of cardboard that includes two flat sides secured to opposing sides of the corrugated sheet.

Polysaccharide-based adhesives are frequently used in the corrugating process due to their desirable adhesive properties, low cost, and ease of preparation. Polysaccharide-based adhesives are typically aqueous mixtures of starch or other polysaccharide, a base compound, a boron-containing compound, and one or more cross-linking compositions. The various cross-linking compositions are generally expensive and make up about 0.26 wt % to about 0.3 wt % of the starch-based adhesive.

In addition to being used in formulating adhesives, polysaccharide-based compositions are also frequently used in formulating sizing compositions for use in the manufacture of paper products, e.g., linerboard, to improve one or more properties thereof, e.g., stiffness, surface strength, and/or print quality. While polysaccharide-based sizing compositions, e.g., starch, can provide one or more improved properties in paper products, further improvements would be beneficial.

There is a need, therefore, for improved polysaccharide-based adhesives for use in making paper products such as cardboard that are free of or use a reduced amount of the cross-linking composition(s). There is also a need, therefore, for improved polysaccharide-based sizing compositions that include a polysaccharide, e.g., starch, for use in making paper products, e.g., linerboard.

### SUMMARY

Compositions, processes for making and using same, and products made therewith are provided. In some embodiments, the composition can include a polysaccharide and an alkyl alcohol alkoxylate that can have a formula of RO[(CH₂CHCH₃O)ₓ(CH₂CH₂O)_{y}]M, where R can be a C₄-C₄₀ alkyl, x can be 1 to 50, y can be 0 to 100, and M can be H or an alkali metal.

In some embodiments, a paper product can include a paper substrate that can include a plurality of fibers and a composition disposed on the fibers. The composition can include a polysaccharide and an alkyl alcohol alkoxylate having a formula of RO[(CH₂CHCH₃O)ₓ(CH₂CH₂O)_{y}]M, where R can be a C₄-C₄₀ alkyl, x can be 1 to 50, y can be 0 to 100, and M can be H or an alkali metal.

In some embodiments, a cardboard product can include a liner and a corrugated sheet. Tips of corrugations of the corrugated sheet can be secured to the liner with an at least partially cured composition. Prior to curing, the composition can include a polysaccharide, a base compound, a boron-containing compound, water, and an alkyl alcohol alkoxylate having a formula of RO[(CH₂CHCH₃O)ₓ(CH₂CH₂O)_{y}]M, where R can be a C₄-C₄₀ alkyl, x can be 1 to 50, y can be 0 to 100, and M can be H or an alkali metal.

### DETAILED DESCRIPTION

It should be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention.

The term “alkyl alcohol” means a compound or mixture of compounds having a formula of ROH, where R is a straight, branched, or ring C₄ to C₄₀ alkyl group.

The term “alkoxy” means an alkyl group attached to the parent molecular moiety through an oxygen atom. Representative alkoxy groups include methoxy, ethoxy, propoxy, butoxy, and the like.

The term “alkyl” means a monovalent group derived from a straight or branched chain or ring saturated hydrocarbon by the removal of a single hydrogen atom. The alkyl can be unsubstituted or substituted with one or more groups selected from amino, alkoxy, hydroxy and halogen. Representative alkyl groups include methyl, ethyl, n- and iso-propyl, n-, sec-, iso- and tert-butyl, and the like.

The term “block polymer” means a polymer resulting from block addition of more than one different type of monomer, such as propylene oxide and ethylene oxide.

The term “homo polymer” means a polymer resulting from the polymerization of one type of monomer, such as propylene oxide or ethylene oxide.

The term “hetero polymer” means a polymer resulting from random addition of more than one type of monomer, such as propylene oxide and ethylene oxide.

### Polysaccharide-Based Sizing Compositions

Polysaccharide-based sizing compositions have long been used in the manufacture of paper products to improve one or more properties thereof. For example, sizing compositions can increase the stiffness, surface strength, and/or print quality of the paper product. The conventional polysaccharide-based sizing compositions typically include a polysaccharide and water such that the sizing composition is in the form of an aqueous mixture or solution. It has been surprisingly and unexpectedly discovered that the addition of an alkyl alcohol alkoxylate to the sizing composition can provide significant improvements in one or more properties of the paper product. For example, one property that can be significantly improved with the addition of the alkyl alcohol alkoxylate can be the cross-machine direction (CD) STFI strength, which can be measured according to the TAPPI T826 test method.

The alkyl alcohol alkoxylate that can be utilized in the polysaccharide-based sizing composition or simply can sizing composition have a formula of RO[(CH₂CHCH₃O)ₓ(CH₂CH₂O)_{y}]M, where R can be a C₄-C₄₀ alkyl, x can be 1 to 50, y can be 0 to 100, and M can be H or an alkali metal. In some embodiments, the alkali metal can be lithium, sodium, potassium, rubidium, or a combination thereof.

In some embodiments, a weight ratio of the polysaccharide to the alkyl alcohol alkoxylate in the sizing composition can be in a range from about 3:1, about 3.5:1, about 5:1, about 7:1, about 10:1, about 15:1, about 20:1, about 25:1, about 30:1, or about 35:1 to about 40:1, about 45:1, about 50:1, about 55:1, about 60:1, about 65:1, about 70:1, or about 75:1.

In some embodiments, the sizing composition can include about 5 wt %, about 7 wt %, or about 8 wt % to about 9 wt %, about 10 wt %, or about 12 wt % of the polysaccharide, based on a combined weight of the polysaccharide, the alkyl alcohol alkoxylate, and the water. In some embodiments, the sizing composition can include about 0.05 wt %, about 0.1 wt %, about 0.5 wt %, about 0.7 wt %, or about 1 wt % to about 1.3 wt %, about 1.5 wt %, about 1.7 wt %, about 2 wt %, about 2.1 wt %, about 2.3 wt %, about 2.5 wt %, about 2.7 wt %, or about 3 wt % of the alkyl alcohol alkoxylate, based on a combined weight of the polysaccharide, the alkyl alcohol alkoxylate, and the water. In some embodiments, the sizing composition can include about 85 wt %, about 87 wt %, or about 89 wt % to about 91 wt %, about 93 wt %, about 94 wt % or about 95 wt % of water, based on a combined weight of the polysaccharide, the alkyl alcohol alkoxylate, and the water.

In some embodiments, the sizing composition can include about 5 wt %, about 7 wt %, or about 8 wt % to about 9 wt %, about 10 wt %, or about 12 wt % of the polysaccharide, about 0.05 wt %, about 0.1 wt %, about 0.5 wt %, about 0.7 wt %, or about 1 wt % to about 1.3 wt %, about 1.5 wt %, about 1.7 wt %, about 2 wt %, about 2.1 wt %, about 2.3 wt %, about 2.5 wt %, about 2.7 wt %, or about 3 wt % of the alkyl alcohol alkoxylate, and about 85 wt %, about 87 wt %, or about 89 wt % to about 91 wt %, about 93 wt %, about 94 wt % or about 95 wt % of water, where all weight percent values are based on a combined weight of the polysaccharide, the alkyl alcohol alkoxylate, and the water. In at least one embodiment, the sizing composition can include about 7 wt % to about 10 wt % of the polysaccharide, about 0.1 wt % to about 2.3 wt % of the alkyl alcohol alkoxylate, and about 87.7 wt % to about 92.9 wt % of the water, based on the combined weight of the polysaccharide, the alkyl alcohol alkoxylate, and the water.

### Polysaccharide-Based Adhesive Compositions

Polysaccharide-based adhesives have long been used in the manufacture of cardboard to secure tips of corrugations of a corrugated sheet to a liner to make the cardboard. The conventional polysaccharide-based adhesives include a polysaccharide, a base compound, a boron-containing compound, a cross-linking composition, and water such that the adhesive is in the form of an aqueous mixture or solution. It has been surprisingly and unexpectedly discovered that the addition of an alkyl alcohol alkoxylate to the adhesive can at least partially or completely replace the cross-linking composition(s) used in conventional polysaccharide-based adhesives while also significantly improving the wet tack strength of the adhesive in the corrugation process. It has also been surprisingly and unexpectedly discovered that the amount of the alkyl alcohol alkoxylate needed for the adhesive to obtain a desired wet tack strength can be significantly less than the cross-linking composition(s) utilized in the conventional polysaccharide-based adhesives. The wet tack strength of the adhesive that includes the alkyl alcohol alkoxylate instead of the conventional cross-linking composition and in a lesser amount can be increased by at least 5%, at least 7%, at least 10%, at least 12%, or at least 14% as compared to the same adhesive without the alkyl alcohol alkoxylate, but with the conventional cross-linking composition(s) at a greater amount than the alkyl alcohol alkoxylate.

The alkyl alcohol alkoxylate that can be utilized in the formulation of the polysaccharide-based adhesive composition or simply adhesive composition can have a formula of RO[(CH₂CHCH₃O)ₓ(CH₂CH₂O)_{y}]M, where R can be a C₄-C₄₀ alkyl, x can be 1 to 50, y can be 0 to 100, and M can be H or an alkali metal. In some embodiments, the alkali metal can be lithium, sodium, potassium, rubidium, or a combination thereof.

In some embodiments, a weight ratio of the polysaccharide to the alkyl alcohol alkoxylate in the adhesive composition can be in a range from about 775:1, about 800:1, about 825:1, about 850:1, about 875:1, about 900:1, about 925:1, about 950:1, about 975:1, or about 1000:1 to about 1050:1, about 1100:1, about 1150:1, about 1200:1, about 1250:1, about 1300:1, or about 1310:1.

In some embodiments, the adhesive composition can include about 15 wt %, about 17 wt %, or about 20 wt % to about 22 wt %, about 24 wt %, or about 26 wt % of the polysaccharide and about 0.005 wt %, about 0.007 wt %, about 0.01 wt %, about 0.013 wt %, or about 0.015 wt % to about 0.017 wt %, about 0.02 wt %, about 0.023 wt %, about 0.025 wt %, about 0.27 wt %, about 0.03 wt %, about 0.033 wt %, or about 0.035 wt % of the alkyl alcohol alkoxylate, based on a combined weight of the polysaccharide, the alkyl alcohol alkoxylate, the base compound, the boron-containing compound, and the water.

In some embodiments, the adhesive composition can include about 15 wt %, about 17 wt %, or about 20 wt % to about 22 wt %, about 24 wt %, or about 26 wt % of the polysaccharide, based on a combined weight of the polysaccharide, the alkyl alcohol alkoxylate, the base compound, the boron-containing compound, and the water. In some embodiments, the adhesive composition can include about 0.005 wt %, about 0.007 wt %, about 0.01 wt %, about 0.013 wt %, or about 0.015 wt % to about 0.017 wt %, about 0.02 wt %, about 0.023 wt %, about 0.025 wt %, about 0.27 wt %, about 0.03 wt %, about 0.033 wt %, or about 0.035 wt % of the alkyl alcohol alkoxylate, based on a combined weight of the polysaccharide, the alkyl alcohol alkoxylate, the base compound, the boron-containing compound, and the water. In some embodiments, the adhesive composition can include about 2.4 wt %, about 2.45 wt %, about 2.5 wt %, about 2.55 wt %, about 2.6 wt %, or about 2.65 wt % to about 2.7 wt %, about 2.75 wt %, about 2.8 wt %, about 2.85 wt %, about 2.9 wt %, about 2.95 wt %, or about 3 wt % of the base compound, based on a combined weight of the polysaccharide, the alkyl alcohol alkoxylate, the base compound, the boron-containing compound, and the water. In some embodiments, the adhesive composition can include about 0.18 wt %, about 0.19 wt %, about 0.2 wt %, about 0.21 wt %, about 0.22 wt %, or about 0.225 wt % to about 0.23 wt %, about 0.235 wt %, about 0.24 wt %, about 0.245 wt %, about 0.25 wt %, about 0.26 wt %, or about 0.27 wt % of the boron-containing compound, based on a combined weight of the polysaccharide, the alkyl alcohol alkoxylate, the base compound, the boron-containing compound, and the water. In some embodiments, the adhesive composition can include about 73 wt %, about 74 wt %, about 75 wt %, or about 76 wt % to about 77 wt %, about 78 wt %, about 79 wt %, or about 80 wt % of the water, based on a combined weight of the polysaccharide, the alkyl alcohol alkoxylate, the base compound, the boron-containing compound, and the water. In at least one embodiment, the adhesive composition can include about 20 wt % to about 22 wt % of the polysaccharide, about 0.01 wt % to about 0.03 wt % of the alkyl alcohol alkoxylate, about 2.6 wt % to about 2.8 wt % of the base compound, about 0.22 wt % to about 0.24 wt % of the boron-containing compound, and about 75 wt % to about 77 wt % of the water, based on a combined weight of the polysaccharide, the alkyl alcohol alkoxylate, the base compound, the boron-containing compound, and the water.

### Components of the Sizing Composition and the Adhesive Composition

Natural unmodified polysaccharide(s) and/or modified polysaccharide(s) can be used to make the sizing composition and the adhesive composition. In some embodiments, the polysaccharide can be or can include, but is not limited to, a starch, a dextrin, a maltodextrin, a cellulose, a gum, or a mixture thereof. In some embodiments, the starch can be or can include, but is not limited to, corn starch, wheat starch, barley starch, tapioca starch, potato starch, sorghum starch, rice starch, sago starch, waxy maze starch, high amylose starch such as high amylose corn, i.e., starch having at least 45% amylose content by weight, or a mixture thereof.

Dextrin is a low molecular weight form of starch produced by processing the starch. More particularly, dextrin can be produced by the hydrolysis of starch or glycogen. In some embodiments, dextrin can be produced from starch using enzymes such as amylases or by applying dry heat under acidic conditions (pyrolysis or roasting). Maltodextrins can be formed by the enzymatic degradation of starch using amylases.

In some embodiments, the polysaccharide can be or can include a conversion product. For example, the polysaccharide can be or can include a converted dextrin prepared by hydrolytic action of acid and/or heat, fluidity or thin boiling starches prepared by enzyme conversion or mild acid hydrolysis, oxidized starches prepared by treatment with oxidants such as sodium hypochlorite, and/or a derivatized or modified starch such as cationic, anionic, amphoteric, non-ionic, crosslinked, and hydroxypropyl starches.

Modified polysaccharides can be or can include, but are not limited to, starch and/or dextrin modified with an alkyl succinic anhydride. In some embodiments, the modified starch and/or the modified dextrin can be modified with octenyl succinic anhydride, dodecenyl succinic anhydride, or a mixture thereof.

The cellulose can be or can include, but is not limited to, carboxymethylcellulose, hydroxypropyl cellulose, hydroxypropyl methylcellulose, or any mixture thereof. The gum can be or can include, but is not limited to, guar, xanthan, pectin, carrageenan, or any mixture thereof.

As noted above, the alkyl alcohol alkoxylate can have the formula of RO[(CH₂CHCH₃O)ₓ(CH₂CH₂O)_{y}]M, where R can be a C₄-C₄₀ alkyl, x can be 1 to 50, y can be 0 to 100, and M can be H or an alkali metal. The C₄-C₄₀ alkyl can be a straight, a branched, or a ring alkyl. In some embodiments, R can be a C₆-C₃₀ alkyl, a C₈-C₂₂ alkyl, a C₁₀-C₂₀ alkyl, or a C₁₄-C₁₈ alkyl. In some embodiments, x can be 1, 2, 4, 6, 8, or 10 to 12, 14, 16, 18, 20, 22, 24, 26, 28, 30, 32, or 34. In some embodiments, y can be 0, 4, 8, 12, 14, 16, 20, 24, 28, 30, 34, 38, or 42 to 46, 50, 56, 60, 66, 70, 74, 78, or 80. In some embodiments, M can be H, Li, Na, or K. In some embodiments, R can be a C₈-C₂₂ alkyl, x can be 1 to 20, y can be 20 to 80, and M can be H or K. In some embodiments, M can be H. In other embodiments, M can be K. In some embodiments, R can be a C₁₆ alkyl. In some embodiments, the alkyl alcohol alkoxylate can be or can include hexadecan-1-ol; 2-methyloxirane; oxirane that has a CAS No. of 9087-53-0.

The alkyl alcohol alkoxylate can be prepared by heating a C₄-C₄₀ alkyl alcohol or mixture of C₄-C₄₀ alkyl alcohols with propylene oxide and, optionally, ethylene oxide in the presence of a hydroxide base. The hydroxide base can be or can include, but is not limited to, one or more hydroxide salts of alkali and/or alkaline metals such as sodium hydroxide, potassium hydroxide, calcium hydroxide, magnesium hydroxide, lithium hydroxide, and the like. In some embodiments, the reaction can be conducted at a temperature of about 140° C. to about 160° C., e.g., about 150° C. at a pressure of about 345 kPa-absolute to about 525 kPa-absolute. The alkyl alcohol alkoxylate can be left in salt form or neutralized with acid.

When the optional ethylene oxide is used to make the alkyl alcohol alkoxylate, the ethylene oxide and propylene oxide can be added in random or block fashion. Random addition of ethylene oxide and propylene oxide involves both components being added to the alcohol simultaneously, such that the rate of addition to the alcohol is controlled by their relative amounts and reaction rates. As such, in the case of random addition, it should be understood that the above formula is not a structural formula but rather is representative only of the molar amounts, x and y, of ethylene oxide and propylene oxide that are reacted with the C₄-C₄₀ alkyl alcohol(s).

In the case of block addition, either the ethylene oxide or propylene oxide can be added first to the alcohol and allowed to react and the other component can then be added and allowed to react. In the case of block addition, the above formula is representative of the structure of the alkyl alcohol alkoxylate, except that the (C₂H₄O)ₓ and the (C₃H₆O)_{y} groups can be reversed depending on whether the propylene oxide or ethylene oxide was added first.

In some embodiments, the alkyl alcohol alkoxylate can be a block polymer, a hetero polymer, a homo polymer or a mixture of two or more of the block polymer, the homo polymer, and the hetero polymer. If the alkyl alcohol alkoxylate is in the form of a mixture that includes at least two of the block polymer, the homo polymer, and the hetero polymer, such mixture can include any ratio of the at least two polymers. For example, if the alkyl alcohol alkoxylate is in the form of a mixture of the block polymer and the hetero polymer, such mixture can include the block polymer in an amount from 0.1 wt %, 1 wt %, 5 wt %, 10 wt %, 15 wt %, 20 wt %, 25 wt %, 30 wt %, 35 wt %, 40 wt %, 45 wt %, or 50 wt % to 55 wt %, 60 wt %, 65 wt %, 70 wt %, 75 wt %, 80 wt %, 85 wt %, 90 wt %, 95 wt %, 99 wt %, or 99.9 wt %, based on the combined weight of the block polymer and the hetero polymer.

The base compound in the adhesive composition can be or can include, but is not limited to, one or more hydroxide salts of alkali and/or alkaline metals such as sodium hydroxide, potassium hydroxide, calcium hydroxide, magnesium hydroxide, lithium hydroxide, and the like, and mixtures thereof. As such, in some embodiments, the base compound that can be combined with the polysaccharide, the alkyl alcohol alkoxylate, the boron-containing compound, and the water to produce the adhesive composition can be the same or different with respect to the hydroxide base used to produce the alkyl alcohol alkoxylate.

The boron-containing compound in the adhesive composition can be or can include any boron-containing compound that has one or more free hydroxyl groups attached to the boron atom(s). In some embodiments, the boron-containing compound can be or can include borax, boric acid, or a mixture thereof. The boric acid can be or can include ortho boric acid (B(OH)₃), metaboric acid, tetra boric acid (H₂B₄O₇), and hydrated forms thereof, e.g., B(OH)₃·(H₂O) n, where n can be 1-5. The borax can be or can include sodium tetraborate decahydrate (Na₂B₄O₇·10H₂O) and other hydrate and anhydrous forms.

The water can be any type of water, e.g., treated tap water, distilled water, deionized water, untreated well-water, and the like. In some embodiments, at least a portion of the water can be sterile, purified water, such as water assigned a CAS No. of 7732-18-5.

### Processes for Making the Sizing Composition and the Adhesive Composition

In some embodiments, the process for making the sizing composition can include mixing the water, the polysaccharide, and the alkyl alcohol alkoxylate to produce the polysaccharide-based sizing composition. The components of the sizing composition can be added to a mixing vessel in any order or sequence. In some embodiments, at least a portion of the water and at least a portion of the polysaccharide can be mixed for a period of time at a temperature about 55° C. or greater, e.g., at a temperature in a range from about 55° C. to about 95° C. In other embodiments, at least a portion of the water and a first portion of the polysaccharide can be mixed for a period of time to produce a first mixture and a second portion of the polysaccharide and additional water can be added to the first mixture that can mixed for another period of time to produce a second mixture. In such embodiments, the components mixed to produce the first mixture and/or the second mixture can be mixed at a temperature about 55° C. or greater. The alkyl alcohol alkoxylate can be added before, during, and/or after the polysaccharide and water have been combined with one another to produce the sizing composition. In some embodiments, the alkyl alcohol alkoxylate can be in the form of an aqueous mixture or solution. As such, in some embodiments, the addition of the alkyl alcohol alkoxylate can also include additional water.

In some embodiments, the process for making the adhesive composition can include mixing the water, the polysaccharide; the base compound; the boron-containing compound; and the alkyl alcohol alkoxylate to produce the adhesive composition. The components of the adhesive composition can be added to a mixing vessel in any order or sequence. In some embodiments, at least a portion of the water, a first portion of the polysaccharide, and at least a portion of the base compound can be mixed for a period of time to produce a first mixture and a second portion of the polysaccharide and the boron-containing compound and additional water and/or base compound can be added to the first mixture that can mixed for another period of time to produce a second mixture. The alkyl alcohol alkoxylate can be added before, during, and/or after the polysaccharide, water, base compound, and boron-containing compound have been combined with one another to produce the adhesive composition. In some embodiments, the alkyl alcohol alkoxylate can be added after the boron-containing compound has been added. For example, the alkyl alcohol alkoxylate can be added to the second mixture that can be mixed for another period of time to produce the adhesive composition. In some embodiments, the alkyl alcohol alkoxylate can be in the form of an aqueous mixture or solution. As such, in some embodiments, the addition of the alkyl alcohol alkoxylate can also include additional water.

### Processes for Making Paper Products

In some embodiments, the sizing composition can be used for internal sizing of paper products, surface sizing of paper products, and/or internal sizing and surface sizing. Internal sizing refers to treatment of a fiber slurry with the sizing composition during manufacture of the paper product. Surface sizing refers to the addition of the sizing composition onto the surface of a dried paper product rather than to the fiber slurry. As such, in some embodiments, a paper product can include a paper substrate that can include a plurality of fibers and the sizing composition disposed on the fibers.

“Papermaking process” or “papermaking” means any portion of a process for making paper products from pulp that can include forming an aqueous cellulosic papermaking furnish, draining the furnish to form a sheet, and drying the sheet. The steps of forming the papermaking furnish, draining and drying may be carried out in any conventional manner generally known to those skilled in the art. The papermaking process may also include a pulping stage, i.e. making pulp from a lignocellulosic raw material and bleaching stage, i.e., chemical treatment of the pulp for brightness improvement, papermaking is further described in the reference Handbook for Pulp and Paper Technologists, 3rd Edition, by Gary A. Smook, Angus Wilde Publications Inc., (2002) and The Nalco Water Handbook (3rd Edition), by Daniel Flynn, McGraw Hill (2009) in general and in particular pp. 32.1-32.44.

The sizing composition can be used to size paper prepared from all types of cellulosic fibers, non-cellulosic fibers, and combinations of cellulosic and non-cellulosic fibers. The cellulosic fibers can be or can include, but are not limited to, sulfate (Kraft), sulfite, soda, neutral sulfite semi-chemical (NSSC), thermomechanical (TMP), chemi-thermomechanical (CTMP), groundwood (GWD), recycled fibers, and any mixture thereof. The cellulosic fibers can be bleached or unbleached. These designations refer to wood pulp fibers that have been prepared by any of a variety of processes that are typically used in the pulp and paper industry. The non-cellulosic or synthetic fibers can be or can include, but are not limited to, rayon, polyethylene, polypropylene, polyester, nylon, or any mixture thereof.

In some embodiments, the sizing composition can be fed to the wet end of a paper machine, which can include thin stock, thick stock, or white water systems. For example, the sizing composition can be fed in the thin stock approach line to a headbox, which can also include a white water system, e.g., pre-fan pump. Although wet end addition of the sizing composition is the norm, any addition point that can introduce the composition to the final paper sheet can yield a sized sheet and can be used. In some embodiments, a mixing chamber can be used to introduce the sizing composition into the papermaking process. Examples of such mixing chambers can include those disclosed in U.S. Pat. No. 7,550,060.

In some embodiments, the sizing composition can be applied to at least one surface of a paper product. For example, the sizing composition can be applied to the surface of the paper using a puddle or film size press or a size press by using a calendar or a doctor knife blade or with a pond sizer coater. In another example, the sizing composition can be sprayed onto the paper web or be applied by dipping the paper into the sizing composition. In some embodiments, the paper product containing the sizing composition on a surface thereof can be allowed to air dry and/or can be heated, e.g., in an oven, to produce the surface sized paper product. Accordingly, sized paper products that include the sizing composition can include the sizing composition as an internal sizing agent, as an external or surface sizing agent, or a combination thereof. Suitable sizing processes can include those disclosed in U.S. Pat. Nos. 4,657,946; 7,455,751; 7,550,060; 8,840,759; and 10,006,171.

The amount of the sizing composition that can be used to size paper can vary depending, for example, on the particular pulp involved, the specific operating conditions, the contemplated end-use of the paper product, and the like. Typical concentrations of the sizing composition, based on the dry weight of the pulp in the finished sheet or web, can be about 5 g, about 50 g, about 100 g, about 250 g, about 500 g, or about 1 kg to about 2 kg, about 5 kg, about 15 kg, about 25 kg, about 35 kg, about 45 kg, about 55 kg, about 65 kg, or more of the polysaccharide based sizing composition per metric ton of dry fiber in the sized paper product. In some embodiments, the amount of the alkyl alcohol alkoxylate that can be present in the sized paper product can be in a range from about 0.3 kg, about 0.5 kg, about 1 kg, about 1.5 kg, about 2 kg, about 2.5 kg, about 3 kg, or about 3.5 kg to about 4 kg, about 5 kg, about 6 kg, about 7 kg, about 8 kg, about 9 kg, about 10 kg, about 11 kg, about 12 kg, about 13 kg, about 14 kg, about 15 kg, or more per metric ton of dry fiber in the sized paper product.

In some embodiments, the sizing composition can also be used in conjunction with or serially with other additives conventionally used in the production of paper and other cellulosic products. Such additional additives conventionally used can include, but are not limited to, colorants, inorganic pigments, fillers, anti-curl agents, surfactants, plasticizers, humectants, defoamers, UV absorbers, light fastness enhancers, polymeric dispersants, dye mordants, optical brighteners, leveling agents, and the like. Other additives, including, for example, alum, as well as other sizing agents, may also be used in the manufacture of paper products.

In some embodiments, a process for making a corrugated sheet can include applying to tips of corrugations of a corrugated sheet the adhesive composition. A liner can be applied to the adhesive composition coated tips of the corrugated sheet. The adhesive composition can be allowed to at least partially cure to secure the corrugated sheet to the liner. In some embodiments, heat can be applied to accelerate the at least partial curing of the adhesive composition. In other embodiments, the adhesive composition can be allowed to at least partially cure in the absence of any applied heat, e.g., the adhesive composition can be allowed to at least partially cure at room temperature. The adhesive composition can be applied to the tips of the corrugations of the corrugated sheet using any suitable process such as dip coating, spraying, brush coating, drum or roller coating, and the like. Typically, the adhesive composition can be applied via drum or roller coating such that the adhesive composition is coated onto the surface of a drum or roller that can contact the corrugations as the corrugated sheet is passed between the adhesive composition coated drum or roller and a cog of a corrugation wheel.

In other embodiments, the process for making single-face corrugated sheet can include applying the adhesive composition to tips of corrugations on a first side of a corrugated sheet having a first and a second side each with a plurality of corrugations that include tips and then applying a liner by aligning the liner with the first side of the corrugated sheet while passing the liner and corrugated sheet through a corrugating roll and a pressure roll. In other embodiments, a double-face corrugated sheet can be made by applying the adhesive composition to tips of corrugations on a first side and on a second side of a corrugated sheet having a first and a second side each with a plurality of corrugations that include tips and then applying a first liner to the first side of the corrugated sheet and a second liner to the second side of the corrugated sheet by aligning the first liner with the first side of the corrugated sheet and the second liner with the second side of the corrugated sheet while passing the liners and corrugated sheet through a corrugating roll and a pressure roll.

In some embodiments, a paper composition, e.g., cardboard, can include at least one liner and a corrugated sheet. In some embodiments, tips of corrugations on a first side of the corrugated sheet can be secured to the liner with an at least partially cured adhesive composition, where, prior to curing, the adhesive composition can include the polysaccharide, the alkyl alcohol alkoxylate, base compound, the boron-containing compound, and the water. In other embodiments, tips of corrugations on a first side and on a second side of the corrugated sheet can be secured to a first liner and a second liner, respectively, with the at partially cured adhesive composition, where, prior to curing, the adhesive composition can include the polysaccharide, the alkyl alcohol alkoxylate, base compound, the boron-containing compound, and the water. The term “at least partially cured” and similar terms is intended to refer to an adhesive composition that has undergone at least some covalent chemical reaction (crosslinking), ionic interaction or clustering, improved adhesion to the substrate, phase transformation or inversion, and/or hydrogen bonding, but may also be capable of undergoing additional covalent chemical reaction (crosslinking), ionic interaction or clustering, improved adhesion to the substrate, phase transformation or inversion, and/or hydrogen bonding.

The cardboard product can be of any product type. In some embodiments, the cardboard product can be a single face board, a single wall board, a double wall board, or a triple wall board. In some embodiments, the paper grades that can be used to make the corrugated sheet and/or the liner can include, but is not limited to, kraft (K) virgin kraft paper, Test 2 (T2) partly recycled liner paper, Test 3 (T) fully recycled liner paper, Chip (C) waste based liners, fully bleached white (BW) fully bleached kraft liner, white top (WT) white coated recycled liner, Mottled kraft (MK) mottled white kraft, oyster (OY) mottled test liner, semi chem (SC) virgin fibers using neutral sulfite semi-chemical process, waste based (WB) 100% recycled fibers, or any combination thereof. In some embodiments, the corrugated sheet and/or the liner can have a paper weight of 125 g/m², 150 g/m², 200 g/m², 300 g/m², or any other desired weight.

In some embodiments, the corrugated sheet can include corrugations or flutes of product type A, B, C, E, or F. When two or more corrugated sheets are present in the cardboard, e.g., in a double wall board product, the product type of the corrugated sheet can be the same or different with respect to one another. For example, the cardboard can be a double wall board that can include a combination of corrugated sheets of product type B and C or E and B, or any other combination of product types.

### Examples

In order to provide a better understanding of the foregoing discussion, the following non-limiting examples are offered. Although the examples can be directed to specific embodiments, they are not to be viewed as limiting the invention in any specific respect. All parts, proportions, and percentages are by weight unless otherwise indicated.

Example I: Inventive sizing compositions (Examples 1-4) were prepared that included an aqueous oxidized starch solution with the alkyl alcohol alkoxylate (hexadecan-1-ol; 2-methyloxirane; oxirane) added at doses of 0.6 kg/metric ton (Ex. 1), 2.0 kg/metric ton (Ex. 2), 4.0 kg/metric ton (Ex. 3), and 7.0 kg/metric ton (Ex. 4). A comparative sizing composition (CEx. 1) was also prepared that contained only water and the oxidized starch. The oxidized starch was starch that underwent an oxidation treatment that introduced carboxyl groups into the structure of the starch. The sizing compositions were coated on virgin linerboard (compression grade) substrate with a pond sizer coater. The viscosity of the inventive sizing compositions at different loadings of the alkyl alcohol alkoxylate slightly increased in relation to the comparative sizing composition, while the percentage of solids increased from 8.3 wt % (CEx. 1) to 8.9% (Ex. 4) that included 7.0 kg/metric ton of the alkyl alcohol alkoxylate.

The sizing composition pickup by weight of starch per metric ton of paper varied non-linearly with the increased loadings of the alkyl alcohol alkoxylate in the sizing compositions; however, the sizing compositions that contained the alkyl alcohol alkoxylate led to an increased starch penetration as compared to the comparative example. As shown in Table 1 below, the addition of the alkyl alcohol alkoxylate to the sizing composition increased the cross-directional STFI strength. More particularly, the paper sheet coated with the alkyl alcohol alkoxylate at 7.0 kg/metric ton showed a gain in cross-directional STFI strength of 20% as compared to an uncoated paper sheet. In contrast, the paper sheet coated with the comparative sizing composition only provided a gain in cross-directional STFI strength of 10% as compared to the uncoated paper sheet. The level of variance in the starch pickup did not have much pull on a strength to weight index basis. Thus, increasing the wet loading of the alkyl alcohol alkoxylate additive in the size press starch solution led to more significant gains in cross-directional STFI strength. The cross-directional STFI strength was measured according to the TAPPI T826 test method.

TABLE 1

| | | | | Solution pickup | CD STFI Index |
|---|---|---|---|---|---|
| | Additive dose | Solution | Solution | (kg of dry | gain (%) in |
| | (kg/metric ton | Viscosity | Solids | starch/metric ton | relation to an |
| Example | of dry starch) | (cP) | (%) | of paper) | uncoated sheet |
| CEx. 1 | 0 (starch only) | 74 | 8.3 | 35.4 | 10 |
| Ex. 1 | 0.6 | 80 | 8.3 | 36.4 | 12 |
| Ex. 2 | 2.0 | 90 | 8.6 | 41.1 | 12 |
| Ex. 3 | 4.0 | 93 | 8.8 | 40.1 | 15 |
| Ex. 4 | 7.0 | 104 | 8.9 | 37.2 | 20 |

Example 11: Double faced cardboard products were prepared and the tension force and adhesion strength between the liner and the corrugated sheet were tested. An inventive adhesive composition (Ex. 5) was prepared by mixing 313 kg of starch, 40.5 kg of NaOH, 3.5 kg of borax, 0.32 kg of hexadecan-1-ol; 2-methyloxirane; oxirane, and 1,142.68 kg of water for 11.5 minutes. A comparative adhesive composition (CEx. 2) was prepared by mixing 313 kg, 40.5 kg of NaOH, 3.5 kg of borax, 4.25 kg of a conventional cross-linking composition, and 1,138.75 kg of water for 11.5 minutes. Cardboard products were made by applying the adhesive compositions to tips of corrugations on a first and second side of a corrugated sheet, applying a first and second line to the adhesive composition coated tips on the first and second sides of the corrugated sheet, respectively, and allowing the adhesive composition to cure to secure the first and second liners to the corrugated sheet. The corrugated sheets had a product grade of E such that the corrugations had a thickness of about 1.2 mm to about 2 mm. The tension force (N) and adhesion strength (N/mm²) were measured according to ASTM D828-22. The results are shown in the Table 2 below.

TABLE 2

| | Product | Tension Force | Adhesion Strength | % |
|---|---|---|---|---|
| Example | Grade | (N) | (N/mm2) | Improvement |
| CEx. 2 | E | 25.21 | 390.78 | |
| Ex. 5 | E | 28.74 | 445.52 | 14.01 |

As shown in Table 2, replacing the conventional cross-linking compound with an alkyl alcohol alkoxylate, i.e., hexadecan-1-ol; 2-methyloxirane; oxirane, increased the tension force/adhesion strength by 14.01%. It should be noted that the inventive adhesive composition used only 0.32 kg of the alky alcohol alkoxylate to replace the 4.25 kg of the conventional cross-linking composition while providing the significant increase in strength. As such, the total cost of the adhesive composition and the amount of the adhesive composition needed to achieve a desired strength can be reduced. For example, the total cost of the adhesive composition can be reduced by about 20% simply by replacing the conventional cross-linking compound with the alkyl alcohol alkoxylate. Without wishing to be bound by theory, it is also believed that the amount of starch can be reduced in the adhesive composition while the adhesive composition can still maintain a desired strength.

Example III: Adhesive compositions were prepared as described above with reference to Example II. Inventive adhesive compositions were prepared that utilized a starch slurry from a glue machine collecting point (GM) and a starch slurry from a single face collecting point (SF). The alkyl alcohol alkoxylate was added to the adhesive solutions at doses of 0.5 kg/ton and 1 kg/ton. Comparative adhesive compositions were also prepared that utilized a starch slurry from a glue machine collecting point (GM) and a starch slurry from a single face collecting point (SF). Instead of the alky alcohol alkoxylate, the comparative adhesive composition contained a conventional cross-linking compound at doses of 0.5 kg/ton and 1 kg/ton. The viscosity of the inventive adhesive composition at 0.5 kg/ton of the alkyl alcohol alkoxylate did not change in relation to the comparative adhesive solution while the addition of 1 kg/ton of the alkyl alcohol alkoxylate resulted in a slight increase in viscosity of the final inventive adhesion composition.

Liner paper (KH, KT grade) and medium grade paper (CSP, CA grade) were cut into 1 in×1 in squares. About 1 mL of adhesive composition was poured between KH and CA and CSP and KT. These two paper samples of different grades were sandwiched together and left to dry. After conditioning, the tension force (N) was measured according to ASTM D828-22. Replacing the conventional cross-linking compound with 0.5 kg/ton of the alkyl alcohol alkoxylate increased the tension force/adhesion strength by 29.59% and 56.16% when using the starch slurry from the GM and the SF, respectively. Replacing the conventional cross-linking compound with 1 kg/ton of the alkyl alcohol alkoxylate increased the tension force/adhesion strength by 66.69% and 59.91% when using the starch slurry from the GM and the SF, respectively.

Embodiments of the present disclosure further relate to any one or more of the following paragraphs:

A1. A composition, comprising: a polysaccharide and an alkyl alcohol alkoxylate having a formula of RO[(CH₂CHCH₃O)ₓ(CH₂CH₂O)_{y}]M, wherein R is a C₄-C₄₀ alkyl, x is 1 to 50, y is 0 to 100, and M is H or an alkali metal.

A2. The composition of paragraph A1, further comprising water.

A3. The composition of paragraph A2, wherein the composition comprises about 7 wt % to about 10 wt % of the polysaccharide and about 0.1 wt % to about 2.3 wt % of the alkyl alcohol alkoxylate, based on a combined weight of the polysaccharide, the alkyl alcohol alkoxylate, and the water.

A4. The composition of any one of paragraphs A1 to A3, wherein a weight ratio of the polysaccharide to the alkyl alcohol alkoxylate is from about 3.5:1 to about 70:1.

A5. A paper product, comprising: a paper substrate comprising a plurality of fibers; and a sizing composition disposed on the fibers, wherein the sizing composition comprises the composition of any one of paragraphs A1 to A4.

A6. A process for making paper, comprising incorporating into the paper or applying to a surface of the paper the composition of any one of paragraphs A2 to A4.

A7. A process for making the composition of any one of paragraphs A2 to A4, comprising mixing the water, the polysaccharide, and the alkyl alcohol alkoxylate to produce the composition.

A8. The composition of paragraph A2, further comprising a base compound and a boron-containing compound.

A9. The composition of paragraph A8, wherein the base compound comprises sodium hydroxide, potassium hydroxide, or a mixture thereof.

A10. The composition of paragraph A8 or paragraph A9, wherein the boron-containing compound comprises borax, boric acid, or a mixture thereof.

All. The composition of any one of paragraphs A8 to A10, wherein the composition comprises about 20 wt % to about 22 wt % of the polysaccharide and about 0.01 wt % to about 0.03 wt % of the alkyl alcohol alkoxylate, based on a combined weight of the polysaccharide, the alkyl alcohol alkoxylate, the base compound, the boron-containing compound, and the water.

A12. The composition of any one of paragraphs A8 to A10, wherein the composition comprises about 20 wt % to about 22 wt % of the polysaccharide, about 0.01 wt % to about 0.03 wt % of the alkyl alcohol alkoxylate, about 2.6 wt % to about 2.8 wt % of the base compound, and about 0.22 wt % to about 0.24 wt % of the boron-containing compound, based on a combined weight of the polysaccharide, the alkyl alcohol alkoxylate, the base compound, the boron-containing compound, and the water.

A13. The composition of any one of paragraphs A8 to A12, wherein a weight ratio of the polysaccharide to the alkyl alcohol alkoxylate is from about 775:1 to about 1310:1.

A14. A process for making cardboard, comprising: applying to tips of corrugations of a corrugated sheet the composition of any one of paragraphs A8 to A13; applying a liner to the composition coated tips of the corrugated sheet; and allowing the composition to at least partially cure to secure the corrugated sheet to the liner.

A15. A process for making the composition of any one of paragraphs A8 to A13, comprising mixing the water, the polysaccharide, the base compound, the boron-containing compound, and the alkyl alcohol alkoxylate to produce the composition.

A16. A cardboard product, comprising: a liner; and a corrugated sheet, wherein tips of corrugations of the corrugated sheet are secured to the liner with an at least partially cured composition, and wherein, prior to curing, the composition comprises the composition of any one of paragraphs A8 to A13.

A17. The composition, process, paper product, or cardboard product of any one of paragraphs A1 to A16, wherein the polysaccharide comprises a starch, a dextrin, a maltodextrin, a cellulose, a gum, or a mixture thereof.

A18. The composition, process, paper product, or cardboard product of any one of paragraphs A1 to A16, wherein the polysaccharide comprises a modified starch or a modified dextrin, wherein the modified starch or the modified dextrin is modified with octenyl succinic anhydride, dodecenyl succinic anhydride, or a mixture thereof.

A19. The composition, process, paper product, or cardboard product of any one of paragraphs A1 to A16, wherein the polysaccharide comprises corn starch, wheat starch, barley starch, tapioca starch, potato starch, sorghum starch, rice starch, sago starch, waxy maze starch, high amylose starch, or a mixture thereof.

A20 The composition, process, paper product, or cardboard product of any one of paragraphs A1 to A19, wherein R is a C₈-C₂₂ alkyl, x is 1 to 20, y is 20 to 80, and M is H or K.

A21. The composition, process, paper product, or cardboard product of any one of paragraphs A1 to A20, wherein M is H.

A22. The composition, process, paper product, or cardboard product of any one of paragraphs A1 to A20, wherein M is K.

A23. The composition, process, paper product, or cardboard product of any one of paragraphs A1 to A22, wherein R is a C₁₄-C₁₈ alkyl.

A24. The composition, process, paper product, or cardboard product of any one of paragraphs A1 to A23, wherein the alkyl alcohol alkoxylate is a block polymer.

A25. The composition, process, paper product, or cardboard product of any one of paragraphs A1 to A23, wherein the alky alcohol alkoxylate is a hetero polymer.

A26. The composition, process, paper product, or cardboard product of any one of paragraphs A1 to A19, wherein the alkyl alcohol alkoxylate comprises hexadecan-1-ol; 2-methyloxirane; oxirane.

Certain embodiments and features have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art. As such, unless otherwise indicated, all numbers indicating quantities in this disclosure are to be understood as being modified by the term “about” in all instances.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. A composition, comprising:
a polysaccharide; and
an alkyl alcohol alkoxylate having a formula of RO[(CH₂CHCH₃O)ₓ(CH₂CH₂O)_{y}]M, wherein R is a C₄-C₄₀ alkyl, x is 1 to 50, y is 0 to 100, and M is H or an alkali metal.

2. The composition of claim 1, further comprising water.

3. The composition of claim 2, wherein a weight ratio of the polysaccharide to the alkyl alcohol alkoxylate is from about 3.5:1 to about 70:1.

4. The composition of claim 2, wherein the composition comprises about 7 wt % to about 10 wt % of the polysaccharide and about 0.1 wt % to about 2.3 wt % of the alkyl alcohol alkoxylate, based on a combined weight of the polysaccharide, the alkyl alcohol alkoxylate, and the water.

5. The composition of claim 2, further comprising a base compound and a boron-containing compound.

6. The composition of claim 5, wherein a weight ratio of the polysaccharide to the alkyl alcohol alkoxylate is from about 775:1 to about 1310:1.

7. The composition of claim 5, wherein the composition comprises about 20 wt % to about 22 wt % of the polysaccharide, about 0.01 wt % to about 0.03 wt % of the alkyl alcohol alkoxylate, about 2.6 wt % to about 2.8 wt % of the base compound, and about 0.22 wt % to about 0.24 wt % of the boron-containing compound, based on a combined weight of the polysaccharide, the alkyl alcohol alkoxylate, the base compound, the boron-containing compound, and the water.

8. The composition of claim 5, wherein the base compound comprises sodium hydroxide, potassium hydroxide, or a mixture thereof.

9. The composition of claim 5, wherein the boron-containing compound comprises borax, boric acid, or a mixture thereof.

10. The composition of claim 1, wherein the polysaccharide comprises a starch, a dextrin, a maltodextrin, a cellulose, a gum, or a mixture thereof.

11. The composition of claim 1, wherein the polysaccharide comprises a modified starch or a modified dextrin, wherein the modified starch or the modified dextrin is modified with octenyl succinic anhydride, dodecenyl succinic anhydride, or a mixture thereof.

12. The composition of claim 1, wherein the polysaccharide comprises corn starch, wheat starch, barley starch, tapioca starch, potato starch, sorghum starch, rice starch, sago starch, waxy maze starch, high amylose starch, or a mixture thereof.

13. The composition of claim 1, wherein R is a C₈-C₂₂ alkyl, x is 1 to 20, y is 20 to 80, and M is H or K.

14. The composition of claim 1, wherein M is H and R is a C₁₄-C₁₈ alkyl.

15. The composition of claim 1, wherein M is K and R is a C₁₄-C₁₈ alkyl.

16. The composition of claim 1, wherein the alkyl alcohol alkoxylate is a block polymer.

17. The composition of claim 1, wherein the alky alcohol alkoxylate is a hetero polymer.

18. The composition of claim 1, wherein the alkyl alcohol alkoxylate comprises hexadecan-1-ol; 2-methyloxirane; oxirane.

19. A paper product, comprising:
a paper substrate comprising a plurality of fibers; and
a composition disposed on the fibers, wherein the composition comprises:
a polysaccharide; and
an alkyl alcohol alkoxylate having a formula of RO[(CH₂CHCH₃O)ₓ(CH₂CH₂O)_{y}]M, wherein R is a C₄-C₄₀ alkyl, x is 1 to 50, y is 0 to 100, and M is H or an alkali metal.

20. A cardboard product, comprising:
a liner; and
a corrugated sheet, wherein tips of corrugations of the corrugated sheet are secured to the liner with an at least partially cured composition, and wherein, prior to curing, the composition comprises:
a polysaccharide,
an alkyl alcohol alkoxylate having a formula of RO[(CH₂CHCH₃O)ₓ(CH₂CH₂O)_{y}]M, wherein R is a C₄-C₄₀ alkyl, x is 1 to 50, y is 0 to 100, and M is H or an alkali metal,
a base compound,
a boron-containing compound, and
water.
